(19) United States
(12) Patent Application Publication
(10) Pub. No.: US 2004/0123089 A1
(43) Pub. Date: Jun. 24, 2004

(54) Method of field upgradeable boot code

(76) Inventor: Melvin Dirk Bodily, Boise, ID (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/327,173

(22) Filed: Dec. 20, 2002

(51) Int. Cl. G06F 9/00

(52) U.S. Cl. 713/1

(57) ABSTRACT

Electronic devices can be initialized in two stages. The first stage of the boot code is stored in normal ROM and is simple in functionality. This first boot code has the responsibility of finding the second stage of the boot code, loading the boot code, and executing the second stage boot code. If no second stage boot code exists, the first stage will watch the I/O for second stage boot code. The only command the first stage boot code recognizes is to download and execute the second stage boot code.

### BACKGROUND

All electronic devices, e.g. cellular phones, handheld games, measurement devices, and computers, require initialization or “boot code”. Boot code is used to test hardware and verify the functionality of the device. The boot code is stored in “read-only memory” (ROM) or other permanent memory. The boot code is the first code executed when power is applied to the device (shown in FIG. 1). The initialization code is becoming more complex as systems increase in intricacy. Since boot code is stored in permanent memory, it is impossible to modify. Modification of the boot code is required to fix bugs and add additional features.

### SUMMARY

Electronic devices can be initialized in two stages. The first stage of the boot code is stored in normal ROM and is simple in functionality. This first boot code has the responsibility of finding the second stage of the boot code, loading the boot code, and executing the second stage boot code. If no second stage boot code exists, the first stage will watch the I/O for second stage boot code. The only command the first stage boot code recognizes is to download and execute the second stage boot code.

### BRIEF DESCRIPTION OF THE DRAWINGS

FIG. 1 illustrates a block diagram of a prior art electronic device.

FIG. 2 illustrates a block diagram of an electronic device of the present invention.

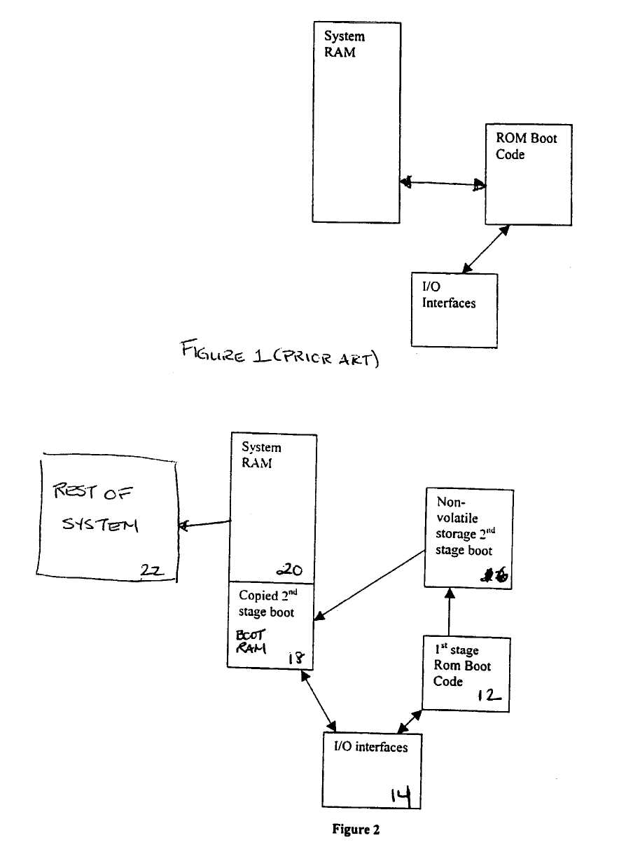

### DETAILED DESCRIPTION

FIG. 2 illustrates a system diagram according to the present invention. The first stage boot code (12) is stored in ROM. The ROM interacts with either I/O interfaces (14) or optional second stage boot code stored in non-volatile storage (16). Both sources of second stage boot code (14, 16) are connected to the boot Random Access Memory (RAM) (18). The boot RAM (18) is connected to the system RAM (20) which initializes the rest of the system (22).

The system diagram is representative of any electronic devices, e.g. cellular phones, handheld games, measurement devices, and computers, which require initialization or “boot code”.

Electronic devices can be initialized in two stages. The first stage of the boot code is stored in normal ROM and is simple in functionality. This first boot code has the responsibility of finding the second stage of the boot code, loading the boot code, and executing the second stage boot code. If no second stage boot code exists, the first stage will watch the I/O for second stage boot code. The only command the first stage boot code recognizes is to download and execute the second stage boot code.

The first stage boot code can verify the second stage boot code by using a CRC or keyword at the start of the code.

The second stage boot code incorporates a routine to also download boot code and store it in non-volatile storage. This allows for field upgrades of the boot code.

The non-volatile storage is ideally a small, inexpensive memory such as a serial electrically erasable programmable read only memory (EEPROM), EEPROM, hard drive, flash memory, etc.

1. An electronic device comprising:
read-only memory storing a first stage boot code;
a second stage boot code;
boot random access memory receives the second stage boot code upon execution by the first stage boot code; and
system memory, connected to the boot random access memory, executes the second stage boot code.

2. An electronic device, as defined in claim 1, wherein the second stage boot code is stored in non-volatile storage.

3. An electronic device, as defined in claim 2, wherein the non-volatile storage is selected from a group that includes serial electrically erasable programmable read only memory (EEPROM), EEPROM, hard drives, and flash memories.

4. An electronic device, as defined in claim 1, further comprising I/O interfaces that receive the second stage boot code.

5. A method of initiating an electronic device comprising:
storing a first stage boot code in read-only memory;
executing the first stage boot code to search for a second stage boot code;
loading the second stage boot code into a boot random access memory; and
executing the second stage boot code.

6. A method of initiating an electronic device, as in claim 5, wherein the second stage boot code is stored in non-volatile storage.

7. An electronic device, as defined in claim 6, wherein the non-volatile storage is selected from a group that includes serial electrically erasable programmable read only memory (EEPROM), EEPROM, hard drives, and flash memories.

8. An electronic device, as defined in claim 5, further comprising I/O interfaces that receive the second stage boot code.
